(19) United States
(12) Patent Application Publication
(10) Pub. No.: US 2017/0144183 A1
(43) Pub. Date: May 25, 2017

(54) EFFICIENT ROBOTIC APPARATUS

(71) Applicants: Alexander I. Jittu, Chesterfield, MI (US); Dana Joseph Gruzd, Troy, MI (US); George William Hilyer, Newport, MI (US)

(72) Inventors: Alexander I. Jittu, Chesterfield, MI (US); Dana Joseph Gruzd, Troy, MI (US); George William Hilyer, Newport, MI (US)

(21) Appl. No.: 14/950,440

(22) Filed: Nov. 24, 2015

(51) Int. Cl. B05B 15/12

(52) U.S. Cl. CPC B05B 15/12; Y10S 901/43

(57) ABSTRACT

An apparatus for manufacturing or painting an article includes a conveyor for transporting articles along a conveyance axis and at least one rail spaced from the conveyance axis. At least a pair of robots is movably mounted on the rail for displacement along the rail. In one aspect, a pair of rails is spaced on opposite sides of the conveyance axis, with at least a pair of robots displacably mounted on each of the pair of rails.

### BACKGROUND

The present disclosure relates to industrial automation, robots and, particularly to painting robots in paint booths.

Robots are commonly used in industrial coating technology systems to apply coating, such as paint, undercoat, overcoat, primer, etc., to articles conveyed through a paint booth on a conveyor or other material handling apparatus.

Multiple robots are frequently employed on both sides of the article and are mounted on longitudinal extending rails supported by a frame in the paint booth or rails mounted on the interior sides of the paint booth. Multiple robots are frequently mounted on each rail so as to provide complete coverage of the article as the article is conveyed though the paint booth.

However, due to the intricacies of coating operations, the paint booths have consume long lengths of valuable plant floor space to provide a sufficient path of movement of the multiple robots on one rail in the paint booth so as to provide complete coating coverage of the article while the article conveyed though the paint booth.

In addition, long rail lengths are necessary prevent interference between the multiple robots during their programmed path of movement along the rails and with respect to the article being coated.

Due to the cost of floor space in a manufacturing facility, an economic advantage can be obtained if the length of the paint booth for particular coating operation can be minimized.

### SUMMARY

An apparatus for manufacturing articles such as painting articles includes a conveyor for conveying articles along a conveyance axis through an area, a first rail is stationarily located with respect to the conveyance axis, and was a plurality of exterior mounting surfaces. First and second robots, any of which may include an articulating arm, are mounted on the first rail for displacement along the first rail. Each of the first and second robots is mounted on a different one of the plurality mounting surfaces of the first rail.

In one aspect, the plurality of mounting surfaces on the first rail has a plurality of polygonal arranged plurality of mounting surfaces. The plurality of mounting surfaces can include at least three angularly disposed mounting surfaces. The three mounting surfaces of the first rail can be arranged in a triangle.

The plurality of mounting surfaces can include four angularly disposed mounting surfaces. The four mounting surfaces include first and second parallel disposed mounting surfaces and third and fourth parallel mounting surfaces. The first and second mounting surfaces are disposed perpendicular to the third and fourth mounting surfaces.

The first and second mounting surfaces can be parallel to the conveyance axis. The third and fourth mounting surfaces can be orthogonal to the conveyance axis.

The mounting surfaces can have other shapes, such as curved, convex or concave.

In one aspect, the first rail can be horizontally spaced to one side of the conveyance axis. In another aspect, the first rail is vertically spaced above the conveyance axis.

The four mounting surfaces can be non-parallel and non-orthogonal to the conveyance axis.

At least one of the first and second robots can include a linear motor to displace the at least one of the first and second robots along the first rail.

A second rail can be stationarily located with respect to the conveyance axis. The first and second rails can be spaced on opposite sides of the conveyance axis.

The plurality of mounting surfaces on the first and second rails can have a plurality of polygonal arranged of mounting surfaces. The plurality of mounting surfaces can include at least three angularly disposed mounting surfaces. The three mounting surfaces can be arranged in a triangle.

The plurality of mounting surfaces on the first and second rails can include four angular disposed mounting surfaces. The four mounting surfaces can include first and second parallel disposed surfaces and third and fourth parallel mounting surfaces. The first and second mounting surfaces are disposed perpendicular to the third and fourth mounting surfaces.

The first and second mounting surfaces can be parallel to the conveyance axis. The third and fourth mounting surfaces can be orthogonal to the conveyance axis.

The mounting surfaces can have other shapes, such as curved, convex or concave.

The four mounting surfaces on the first and second rails can be non-parallel and non-orthogonal to the conveyance axis.

At least one of the first and second robots can include a linear motor to displace the at least one of the first and second robots along the first rail.

Any of the mounting surfaces on the first and/or second rails can be formed as a flat mounting surface or take any other shape, such as an elliptical or curved shape, including convex and concave surfaces.

### BRIEF DESCRIPTION OF THE DRAWINGS

The various features, advantages and other uses of the present robotic apparatus will become more apparent by referring to the following detailed description and drawing in which:

FIG. 1 is a perspective view of one aspect of a robotic apparatus;

FIG. 2 is a cross sectional view generally taken along line 2-2 in FIG. 1;

FIG. 3 is a side elevational view of the robotic apparatus shown in FIG. 1;

FIG. 4 is a partial longitudinal cross sectional view showing alternate mounting positions of the robots on one rail of the robotic apparatus;

FIG. 5 is a partial longitudinal cross sectional view of another aspect of the robotic apparatus showing alternate mounting positions of the robots on one rail of the robotic apparatus;

FIG. 6 is longitudinal cross sectional view of showing another aspect of an alternate mounting position of the robots;

FIGS. 7 A, 7B, and 7C are longitudinal cross-sectional views showing different aspects of the mounting surfaces on a rail of the robotic apparatus; and

FIG. 8 is a perspective view of a linear motor for driving the robots along the rails.

### DETAILED DESCRIPTION

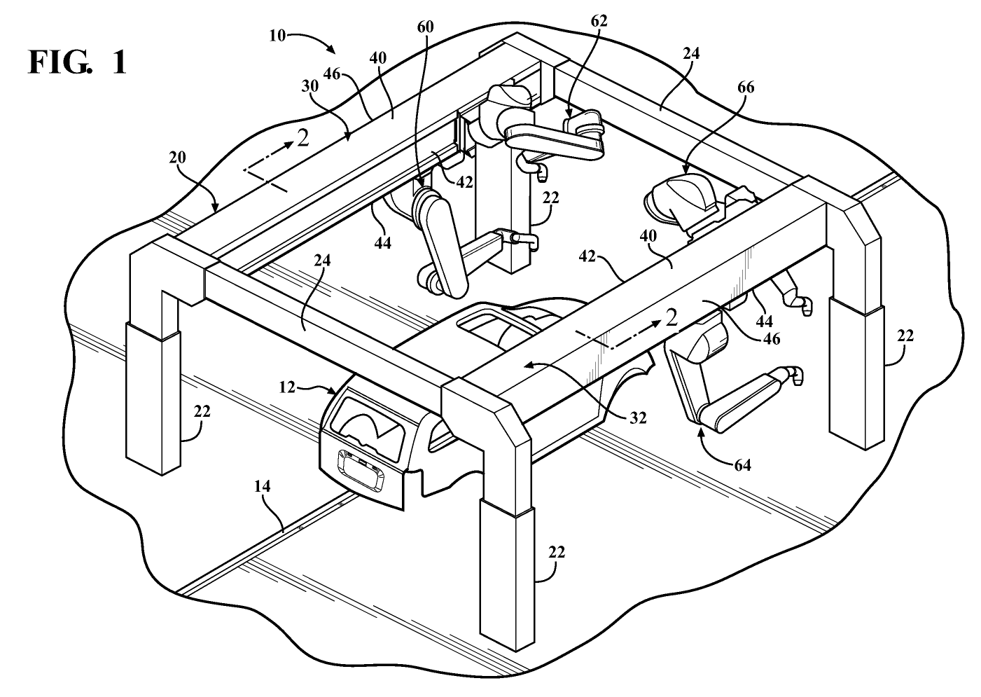

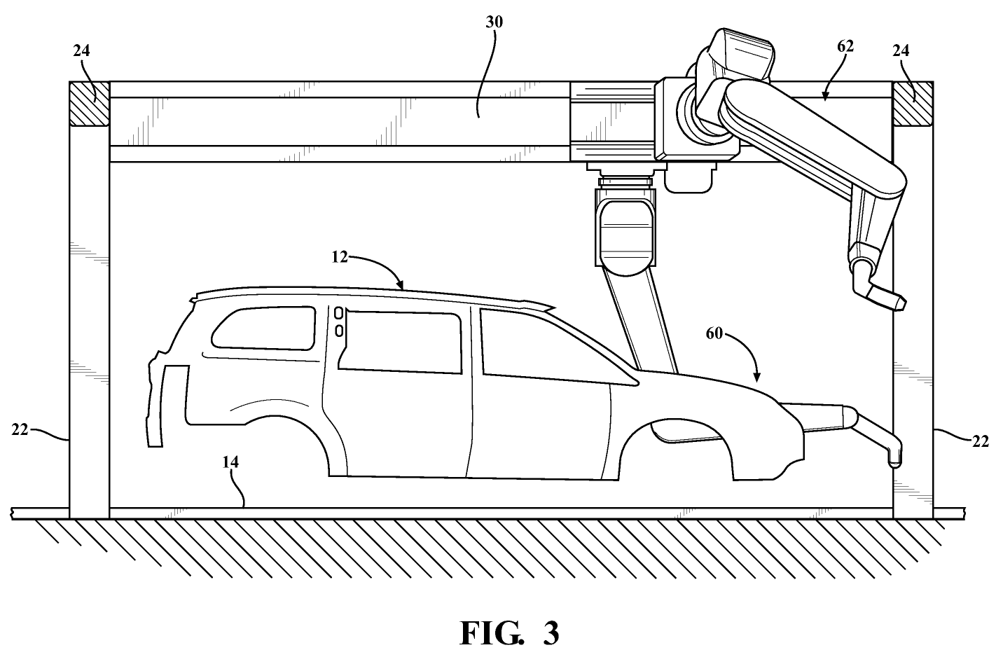

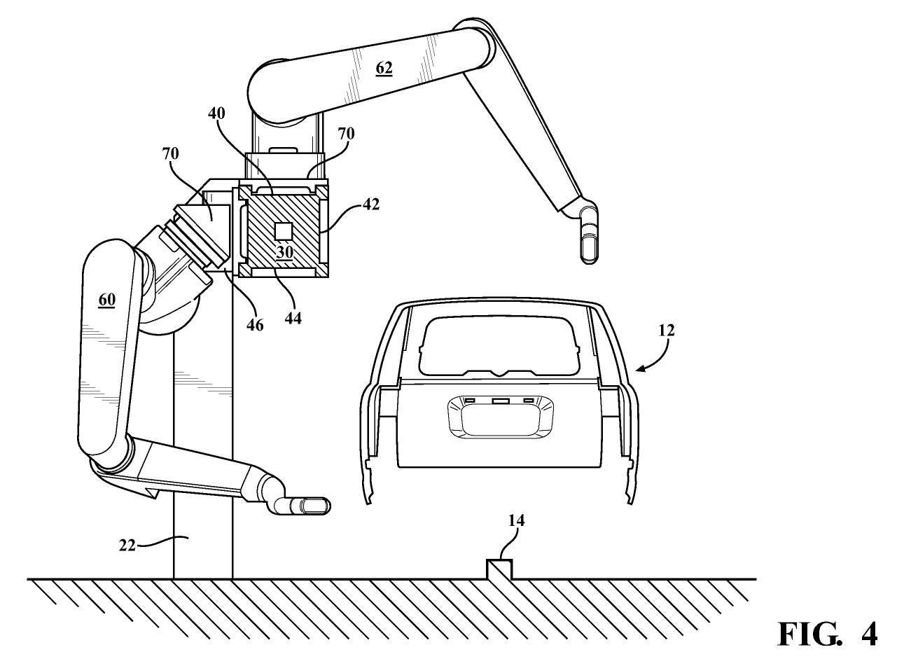

Referring now to FIGS. 1-6, there is depicted a robotic apparatus 10 (“apparatus 10”), described hereafter, by example, as a robotic painting apparatus configured for applying a coating such as paint, overcoat, primer, undercoat, etc., all hereafter described as “painting” to an article 12 depicted herein by example as an automobile body as the body moves through a painting or coating location by means of a conveying apparatus, such as conveyor 14.

Although the robotic apparatus 10 is described hereafter as being used in a painting application for applying a coating to the article 12, it will be understood that the present efficient robotic apparatus is applicable to many other robotic manufacturing or automation applications, such as welding, assembly, dimension checking, etc.

It will also be understood that while the robots described hereafter as being used in the robotic apparatus 10 are configured as painting robots, different application robots may be mounted on the same rail in the robotic apparatus 10, such as one painting robot and one assembly robot, such as a door or deck lid opening and closing robot, as well as robots configured for other manufacturing, material handling and sealing applications.

Although not shown in FIGS. 1-6, the apparatus 10 is mounted in a painting booth having an entrance and an exit for the conveyor 14 and the article 12.

The apparatus 10 includes a frame 20 having, for example, a plurality, such as four vertical posts 22 fixed at their lower ends to a floor surface within the paint booth, a pair of opposed upper end frame members 24 connected at opposite ends and spanning a distance between pairs of the vertical posts 22. At least one or more, longitudinally extending rails, with two rails 30 and 32 shown by example, are supported at opposite ends to opposed spaced pairs of the vertical posts 22 between the end frame members 24.

The longitudinally extending first and second rails, hereafter referred to simply as the rails 30 and 32, are depicted as being mounted at the upper ends of the vertical posts 22, it will be understood that the rails 30 and 32 may be mounted at other intermediate positions along the vertical extent of the vertical posts 22.

Further, the rails 30 and 32 are general disposed parallel to each other; although other angular, nonparallel orientations can also be employed.

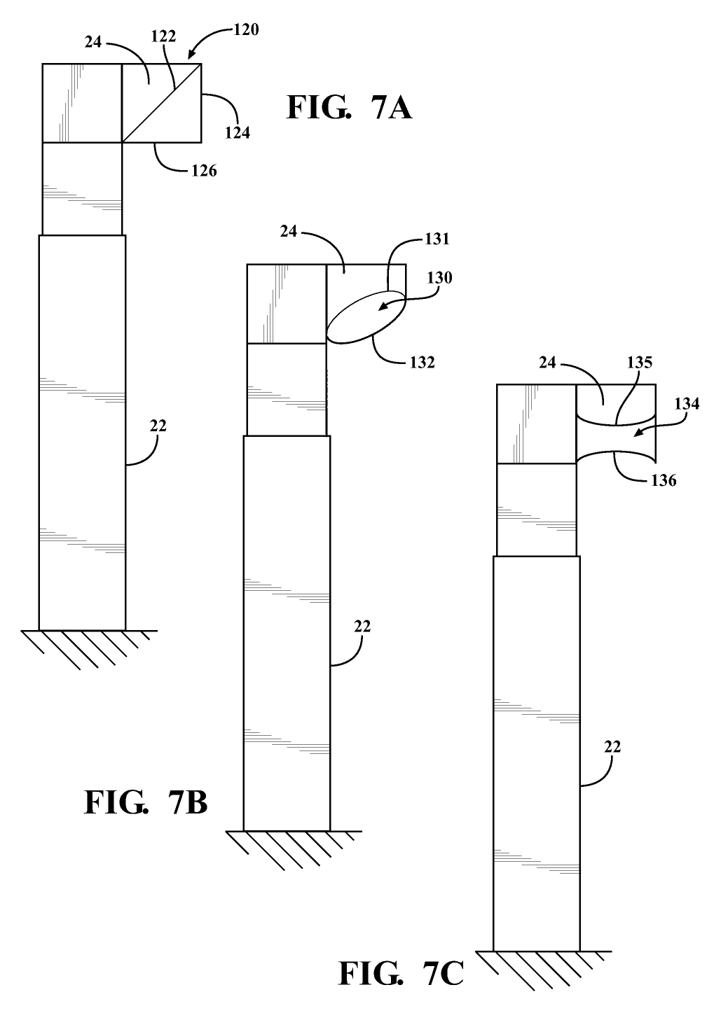

Each rail 30 and 32 has, for example, a polygonal cross sectional shaped formed of a plurality of generally flat mounting surfaces, with four mounting surfaces 40, 42, 44 and 46 shown by example in FIGS. 1-6. It will be understood that each rail 30 and 32 may have other cross sectional shapes not totally defining a polygonal cross section but with a plurality of generally planar mounting surfaces 40, 42, etc. Although four mounting surfaces 40, 42, 44 and 46 are depicted by example in FIGS. 1-6, other polygonal shapes with a different number of mounting surfaces such as, a three sided triangular rail shown in FIG. 7 can also be employed.

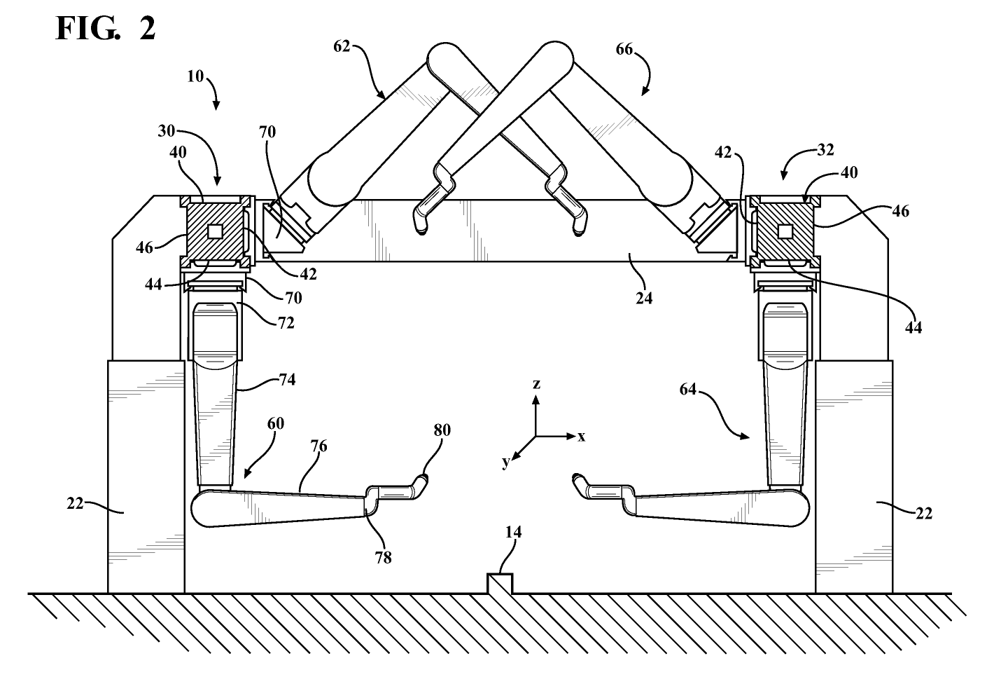

As shown in FIG. 2, the mounting surfaces 40, 42, 44, and 46 of each rail 30 and 32 are arranged as orthographic surfaces disposed generally perpendicular to each other. In a typical mounting orientation in a paint booth, the mounting surfaces 42 and 46 of each rail 30 and 32 generally face along a horizontal or X-axis direction in the painting booth. Mounting surfaces 40 and 44 of each rail 30 and 32 generally lie or face a vertical or Z-axis direction.

By way of example, a plurality of painting robots may be mounted on each rail 30 and 32. Although all of the painting robots are described as painting robots, at least one robot, on one rail can dispense paint, while the other painting robot can be a non-paint dispensing robot, such as a deck lid opener or closer robot. By example, two painting robots 60 and 62 are moveably mounted on the rail 30. Similarly, by example, two painting robots 64 and 66 are mounted on the rail 32. It will be understood that the number of painting robots mounted on each rail 30 and 32 may be the same or different depending upon the painting application and the articles to be painted. Further, while each painting robot 60, 62, 64 and 66 is illustrated in FIGS. 1-7 as described hereafter, as being substantially identically constructed, it will be understood that the painting robots 60, 62, 64 and 66 may have different constructions from each other to suit the needs of a particular painting or coating application.

Thus, by way of example, following the description of the components of the painting robot 60 will be understood to apply to the other painting robots 62, 64 and 66.

The painting robot 60 includes a robot to rail connector or base 70. The base 70 is movably coupled to the rail 30 as described hereafter, for longitudinal movement along the rail 30. A first robot arm 72 is pivotally coupled to the base 70 for rotation about an axis perpendicular to the base 70. A second robot arm 74 is pivotally coupled to the first robot arm 72 for movement relative to the first robot arm 72 about an axis perpendicular to the longitudinal extent of the second robot arm 74. A third robot arm 76 is pivotally coupled to a joint at one end of the second robot arm 74 for further pivotal movement about an axis defined by the joint perpendicular to the longitudinal axis of the second robot arm 74 and third robot arm 76. A wrist joint 78 is mounted the end of the third robot arm 76 and supports an applicator 80, such as a spray gun, for applying a fine particulate fluid, such as paint, to an article.

The painting robot 60 is coupled to a seven axis drive motor and controller, not shown, which, under program control, moves the painting robot 60 longitudinally along the rail 30, while pivoting any or all of the first, second and third robot arm 72, 74 and 76 to position the applicator 80 in the proper position to continuously, or in a discontinuous manner, apply paint to an article passing through the paint booth on the conveyor 14.

According to one aspect, painting the robots mounted on each rail, such as the pair of painting robots 60 and 62 mounted on the rail 30 and the pair of painting robots 64 and 66 mounted on the opposite rail 32 are mounted on different mounting surfaces of the rails 30 or 32. Thus, by example, the base 70 of the painting robot 60 is mounted on the lower disposed horizontal mounting surface 44 of the rail 30; while the base 70 of the other of the robot pair associated with rail 30 is mounted on a different mounting surface, such as inside vertical mounting surface 42 of the rail 30. Similarly, the painting robot 64 of the robot pair associated with the opposed rail 32 is also mounted on the bottom or lower most horizontal mounting surface 44 of the rail 32. The other painting robot 66 of the robot pair associated with rail 32 is mounted on the inside vertically extending mounting surface 42 of the rail 32.

This mounting arrangement of the painting robots associated with each rail on a different mounting surface of each rail affords any efficient and compact painting booth having a length substantially shorter than prior art paint booths employing multiple robots mounted on the same rail. The use of different mounting surfaces for the robot associated with each rail 30 or 32 allows greater versatility in the program path of travel of the painting robots 60 and 62 without interference. In this manner, the painting robots 60 and 62 can actually pass each other in opposite directions during their programed path of movement.

This efficient design of the programed path of movement of the robots on different mounting surfaces of the same rail 30 or 32 allows the robots to be placed on the respective rails 30 and 32 for each optimal work envelope. Depending upon the application, the rails 30 and 32 can be positioned to allow the work envelope of each robot mounted on each rail to encompass the entire article or vehicle 12. This is in spite of defined work path, i.e., horizontal or vertical mounting surfaces on each rail, the robots still have the ability to assume the defined work area of the other robot on the respective rail in case of a mechanical failure or breakdown.

For example, in a typical prior art paint booth, two robots on the same rail share the length of the rail for their defined work envelopes. For example, in the case of a 30 foot long rail, if one robot utilizes 20 feet of the rail for its work envelope, the second robot is confined to the remaining 10 feet of the rail since both robots are mounted on the same longitudinally extending mounting surface of the rail. The apparatus 10 allows both robots to utilize the full 30 feet of the rail.

It should be noted in one aspect of the painting apparatus 10; the bases 70 use to movably couple each painting robot 60, 62, 64 and 66 to one of the rails 30 or 32 can have an angular offset, such as the base 70 associated with the painting robots 62 and 66. One surface of the base 70 is movably coupled to the mounting surface 42 of the rail 30 or 32. The outlet of coupling end of the base 70, which is coupled to one end of the first robot arm of each painting robot 62 or 66, is disposed at an angle between 0° and 90°, such as at a 45° angle, for example, relative to the surface of the base 70 associated with the mounting surface on the rail 30 or 32.

Conversely, the base 70 associated with the painting robot 60 can lack an angular offset such that the pivot axis of the end of the first robot arm 74 of the painting robot 60 coupled to the base 70 is perpendicular to the coupling end of the base 70 as well as the opposed surface of the base 70 movably coupled to the lower most mounting surface 44 of the rail 30.

The painting robots 60 and 62 associated with the rail 30 may be mounted on other mounting surfaces, such as mounting surface 40 for the base 70 of the painting robot 62 and mounting surface 46 for the base 70 of the painting robot 60.

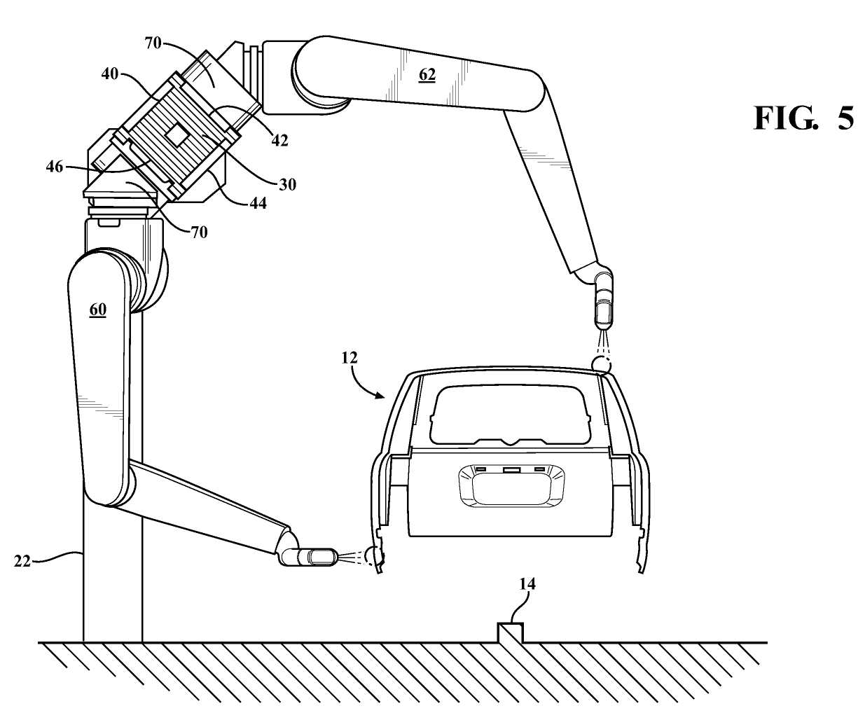

The rails 30 and 32 described above and shown in FIGS. 1-4 have been disposed in an orthographic or right angle orientation with respect to the vertical posts 22 and the underlying floor surface of the paint booth. In FIG. 5, the rail 30, by example, is disposed at a non-orthographic angle, such as a 45° angle or other angle, for example, with respect to the vertical post 22 and the underlying floor of the paint booth. The pair of painting robots 60 and 62 is coupled to different mounting surfaces 40, 42, 44 and 46 of the rail 30, as described above. The bases 70 of each painting robot 60 and 62 may have a perpendicular or angular offset configuration as also described above, relative to the adjacent mounting surface of the rail 30.

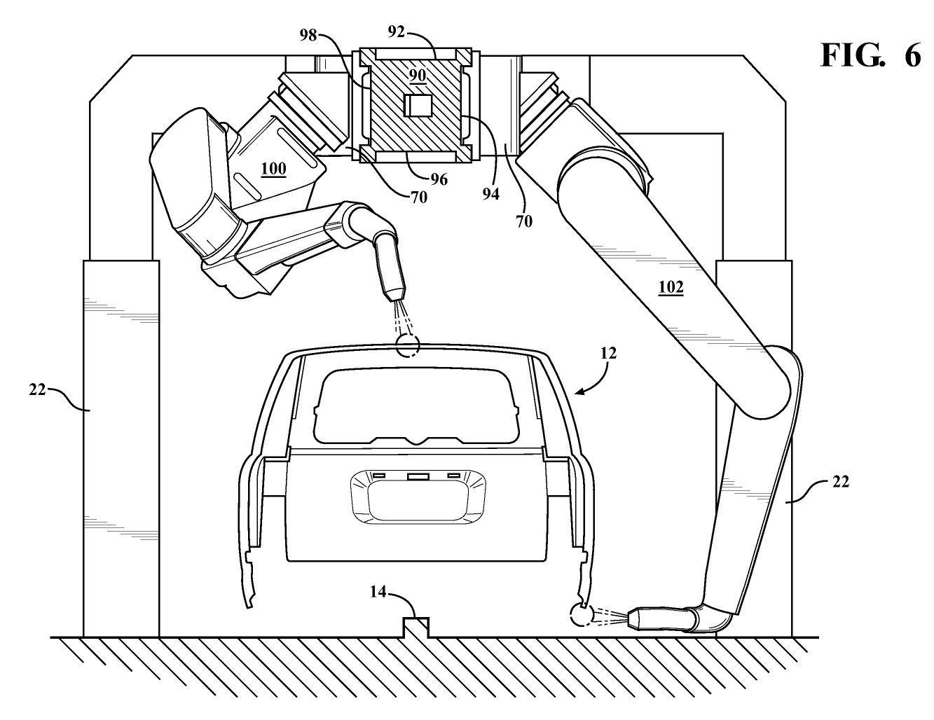

FIG. 6 depicts another aspect of the robotic painting apparatus 10 in which the pair of rails 30 and 32 are replaced by a single overhead longitudinally extending rail 90 supported at opposite ends by the end frame members 24 and situated substantially centrally relative to the vertical posts 22 and the conveyance axis.

As in other aspects of the robotic painting apparatus 10 described above, pair of painting robots 100 and 102, which may be identical to any of the robots 60, 62, 64 or 66, are mounted on different ones of the mounting surfaces 92, 94, 96 and 98 of the rail 90. It should also be noted that the bases 70 of the painting robots 100 and 102 may have the angular offset configuration or a straight perpendicular attachment configuration relative to the associated mounting surface of the rail 90.

In FIG. 7A the polygonal cross sectional shape of the rails used in the painting apparatus 10 is illustrated as being in the form of a three sided polygon for the rail 120. The rail 120 includes three exterior mounting surfaces 122, 124 and 126 which may be disposed at any angle relative to each other, such as may be the case for an isosceles, equilateral or scalene triangular shaped rail 120. As in other aspects of the painting apparatus 10, a pair of painting robot can be mounted on different ones of the mounting surfaces 122, 124 and 126 for independent or simultaneous operation.

FIGS. 7B AND 7C depict alternate mounting surface configurations for the rails. In FIG. 7B, the rail 130 has elliptical or arcuate opposed mounting surfaces 131 and 132. In this aspect, the mounting surfaces 131 and 132 have a convex shape. The attachment surfaces for the robots mounted on the rail 130 will have a shape complimentary to the elliptical or arcuate shape of the mounting surfaces 131 and 132 of the rail 130.

In FIG. 7C, a mounting rail 134 is depicted as also having elliptical or curved exterior mounting surfaces. In this aspect, the mounting surfaces 135 and 136 are depicted as having a convex shape.

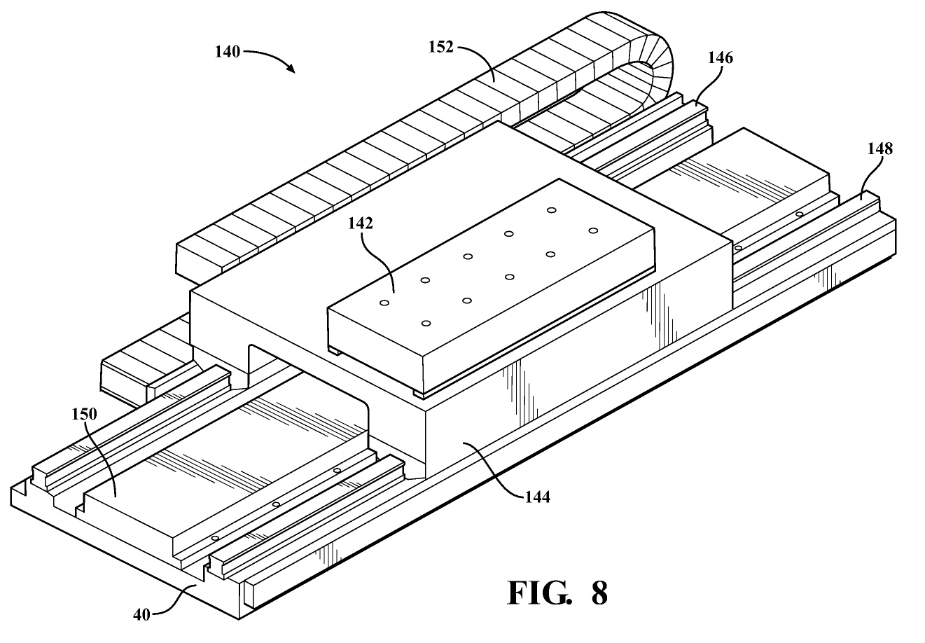

Referring now to FIG. 8, there is depicted a linear motor 140 which may be used as a replacement for the seven axis motor used in many painting robots. The linear motor 140 has a compact shape including a primary motor part 142 mounted on a base 144 slidable along linear guide ways 146 and 148 mounted on a mounting surface, such as mounting surface 40 of the rail 30. A secondary motor part 150 is also mounted on the rail mounting surface 40 and cooperates with the primary motor part 142 to move the base 144 longitudinally along the rail 30 in a bidirectional manner. The base 70 of the painting robot can be mounted on the base 144. Likewise, a cable guide 152 adjacent to the mounting surface 40 provides cable protection and feed during movement of the base 144 along the rail 30.

1. An apparatus for manufacturing articles comprising:
a conveyor for transporting articles along a conveyance axis;
a first rail stationarily located with respect to the conveyance axis, the first rail having a plurality of mounting surfaces;
first and second robots mounted on the first rail for displacement along the first rail; and
each of the first and second robots mounted on a different one of the plurality mounting surfaces on the first rail.

2. The apparatus of claim 1 further comprising:
the plurality of mounting surfaces on the first rail having a polygonal arranged plurality of mounting surfaces.

3. The apparatus of claim 2 wherein the plurality of mounting surfaces includes at least three angularly disposed mounting surfaces arrange in a triangle.

4. The apparatus of claim 2 wherein:
the plurality of mounting surfaces includes four angularly disposed mounting surfaces.

5. The apparatus of claim 4 comprising:
the four mounting surfaces including first and second parallel disposed mounting surfaces and third and fourth parallel mounting surfaces, the first and second mounting surfaces disposed perpendicular to the third and fourth mounting surfaces.

6. The apparatus of claim 5 wherein:
the first and second mounting surfaces are parallel to the conveyance axis; and
the third and fourth mounting surfaces are orthogonal to the conveyance axis.

7. The apparatus of claim 5 wherein:
the four mounting surface are non-parallel and non-orthogonal to the conveyance axis.

8. The apparatus of claim 1 further comprising:
the plurality of mounting surfaces on the first rail have an arcuate exterior shape.

9. The apparatus of claim 1 wherein:
the first rail is horizontally spaced to one side of the conveyance axis.

10. The apparatus of claim 1 wherein:
the first rail is vertically spaced above the conveyance axis.

11. The apparatus of claim 1 wherein:
the first and second robots include at least one painting robot to dispense paint onto articles moving along the conveyance axis.

12. The apparatus of claim 1 further comprising:
at least one of the first and second robots including a linear motor to displace the at least one of the first and second robots along the first rail.

13. The apparatus of claim 1 furthering comprising:
a second rail stationarily located with respect to the conveyance axis; and
the first and second rails spaced on opposite sides of the conveyance axis.

14. The apparatus of claim 13 further comprising:
the plurality of mounting surfaces on the first rail having a polygonal arranged plurality of mounting surfaces.

15. The apparatus of claim 14 wherein:
the plurality of mounting surfaces includes three mounting surfaces arranged in a triangle.

16. The apparatus of claim 14 wherein:
the plurality of mounting surfaces includes four angularly disposed mounting surfaces where the four mounting surfaces include first and second parallel disposed mounting surfaces and third and fourth parallel mounting surfaces, the first and second mounting surfaces disposed perpendicular to the third and fourth mounting surfaces.

17. The apparatus of claim 16 wherein:
the first and second mounting surfaces are parallel to the conveyance axis; and
the third and fourth mounting surfaces are orthogonal to the conveyance axis.

18. The apparatus of claim 1 wherein:
the four mounting surfaces are non-parallel and non-orthogonal to the conveyance axis.

19. The apparatus of claim 1 wherein:
the plurality of mounting surfaces on the first rail have an arcuate exterior shape.

20. The apparatus of claim 1 wherein:
the first and second robots include at least one painting robot to dispense paint onto articles moving along the conveyance axis.
